(19) United States
(12) Patent Application Publication
(10) Pub. No.: US 2021/0356335 A1
(43) Pub. Date: Nov. 18, 2021

(54) SENSORS FOR ROBOTIC MANIPULATION

(71) Applicant: BeBop Sensors, Inc., Berkeley, CA (US)

(72) Inventors: Keith A. McMillen, Berkeley, CA (US); Kyle Lobedan, Oakland, CA (US); William Walls, Oakland, CA (US)

(21) Appl. No.: 17/302,955

(22) Filed: May 17, 2021

Related U.S. Application Data
(60) Provisional application No. 63/026,478, filed on May 18, 2020.

(51) Int. Cl. G01L 1/18; G01L 5/00; B25J 13/08

(52) U.S. Cl. CPC G01L 1/18; B25J 13/085; G01L 5/0061

(57) ABSTRACT

Components and sensors for robotic manipulators are described that enable grasping and manipulation of objects with a high degree of resolution.

### INCORPORATION BY REFERENCE

An Application Data Sheet is filed concurrently with this specification as part of this application. Each application to which this application claims benefit or priority as identified in the concurrently filed Application Data Sheet is incorporated by reference herein in its entirety and for all purposes.

### BACKGROUND

Robotics are entering many facets of human life. Interaction with the environment and objects in the environment in many ways define the expectations we have of robotics. The field of robotics has made great strides with high resolution cameras, infrared and ultrasonic transducers, Lidar, and audio processing. However, none of these sensing systems plays a useful role when the robot/object interactions become intimate. Understanding the changing surface of held objects and the forces with which they are grasped has been a human skill that must be implemented in robots to make them truly useful in taking on human tasks.

Existing robotic manipulators vary from two element grippers to anthropomorphic robotic hands. These manipulators are expected to handle a wide variety of objects from mechanical assemblies, electronic devices, agriculture, apparel, and many more. Accurate force sensing by such manipulators is essential for the robotic system to “know” the object, its orientation, and function. Conventionally, sensors have been limited in resolution, reliability, density, accuracy, and repeatability. As a result, complex shapes are reduced to low order geometries for most robotic systems. Cost has also been a problem with traditional sensors costing many dollars per sensing element.

### SUMMARY

According to a particular class of implementations, a device includes a component having a plurality of distinct exterior surfaces. A sensor array is arranged on a flexible substrate. The sensor array includes a plurality of sensors. The flexible substrate is configured to fold such that the flexible substrate substantially conforms to the exterior surfaces of the component. Each of a plurality of distinct subsets of the sensors is aligned with a corresponding one of the exterior surfaces of the component. Associated circuitry is configured to receive sensor signals from the sensors of the sensor array, and to process the sensor signals to generate force data representing forces on the device.

According to a specific implementation of this class, a beam is disposed within an interior volume of the component. The beam is aligned with a central axis of the component and includes one or more strain gauges integrated therewith. The beam is configured to be secured within the component such that the forces on the device cause the beam to flex. The circuitry is configured to receive one or more strain gauge signals generated using the one or more strain gauges, and to generate the force data using the one or more strain gauge signals. According to a more specific implementation, the circuitry is configured to determine a force magnitude for a first force using the one or more strain gauge signals, and a force location for the first force using the sensor signals. According to another more specific implementation, the beam is secured to the component at a first end of the beam, and the beam is configured to be secured to an external structure at a second end of the beam. According to another more specific implementation, the beam has a rectangular cross-section. According to an even more specific implementation, the one or more strain gauges include a first strain gauge integrated with a first face of the beam and a second strain gauge integrated with a second face of the beam. According to an even more specific implementation, the first and second strain gauges are oriented differently relative to the axis of the component.

According to another specific implementation of this class, at least one of the exterior surfaces of the component is substantially flat.

According to another specific implementation of this class, at least one of the exterior surfaces of the component is curved.

According to another specific implementation of this class, each sensor of the sensor array includes at least two conductive sensor traces and piezoresistive material in contact with the sensor traces. According to a more specific implementation, the piezoresistive material is a piezoresistive fabric. According to another more specific implementation, the piezoresistive material of each sensor is part of a contiguous substrate of the piezoresistive material that coincides with more than one of the sensors. According to another more specific implementation, the piezoresistive material of each sensor is a patch of the piezoresistive material that coincides with only the corresponding sensor.

According to another specific implementation of this class, a silicone cover encases the component and the sensor array.

According to another specific implementation of this class, the circuitry is contained within an interior volume of the component.

According to another specific implementation of this class, the circuitry is configured to generate the force data with a positional resolution limited by a number of the sensors in the sensor array.

According to another specific implementation of this class, the circuitry is configured to generate the force data with a positional resolution that is greater than a limit defined by a number of the sensors in the sensor array. According to a more specific implementation, each of the sensors is characterized by a sensor trace topology, and the sensor trace topology for a first sensor is flipped relative to the sensor trace topology of a second sensor that is adjacent the first sensor.

According to another class of implementations, a device includes a component and a beam within an interior volume of the component. The beam is aligned with a central axis of the component and includes one or more strain gauges integrated therewith. The beam is configured to be secured within the component such that forces on the device cause the beam to flex. Associated circuitry is configured to receive one or more strain gauge signals generated using the one or more strain gauges, and to generate force data representing the forces on the device using the one or more strain gauge signals.

According to a specific implementation of this class, a sensor array is arranged on one or more exterior surfaces of the component. The circuitry is configured to determine a force magnitude for a first force using the one or more strain gauge signals, and a force location for the first force using sensor signals received from the sensor array. According to a more specific implementation, the component has a plurality of distinct exterior surfaces, wherein sensors of the sensor array are arranged on a flexible substrate, and wherein the flexible substrate is configured to fold such that the flexible substrate substantially conforms to the exterior surfaces of the component, and such that each of a plurality of distinct subsets of the sensors is aligned with a corresponding one the exterior surfaces of the component.

According to another specific implementation of this class, the beam is secured to the component at a first end of the beam, and the beam is configured to be secured to an external structure at a second end of the beam.

According to another specific implementation of this class, the beam has a rectangular cross-section. According to a more specific implementation, the one or more strain gauges include a first strain gauge integrated with a first face of the beam and a second strain gauge integrated with a second face of the beam. According to an even more specific implementation, the first and second strain gauges are oriented differently relative to the axis of the component.

A further understanding of the nature and advantages of various implementations may be realized by reference to the remaining portions of the specification and the drawings.

### BRIEF DESCRIPTION OF THE DRAWINGS

FIGS. 1A and 1B show different views of a robotic manipulator member enabled by the present disclosure.

FIG. 2 shows a particular implementation of a sensor array enabled by the present disclosure.

FIG. 3 shows a particular implementation of sensor circuitry enabled by the present disclosure.

FIG. 4 shows a component of a robotic manipulator enabled by the present disclosure.

FIG. 5 shows a partial cross-section of a component of a robotic manipulator enabled by the present disclosure.

FIG. 6 shows another implementation of a sensor array enabled by the present disclosure.

FIG. 7 shows another implementation of a sensor array enabled by the present disclosure.

FIG. 8 shows another component of a robotic manipulator enabled by the present disclosure.

FIG. 9 illustrates crosstalk between adjacent sensors of a sensor array.

FIGS. 10A and 10B illustrate enhancement of positional resolution of a sensor array.

FIG. 11 shows a robotic hand enabled by the present disclosure.

FIG. 12 shows a cross-section of another component of a robotic manipulator enabled by the present disclosure.

### DETAILED DESCRIPTION

Reference will now be made in detail to specific implementations. Examples of these implementations are illustrated in the accompanying drawings. It should be noted that these examples are described for illustrative purposes and are not intended to limit the scope of this disclosure. Rather, alternatives, modifications, and equivalents of the described implementations are included within the scope of this disclosure as defined by the appended claims. In addition, specific details may be provided in order to promote a thorough understanding of the described implementations. Some implementations within the scope of this disclosure may be practiced without some or all of these details. Further, well known features may not have been described in detail for the sake of clarity.

This disclosure describes devices and systems that employ sensor technology for use in robotic systems. Sensor systems are described herein that increase resolution significantly relative to conventional robotic manipulators. Some of these sensors are compliant and can conform to robotic manipulator members and/or objects as they are being gripped by robotic manipulators with varying force. An example will be instructive.

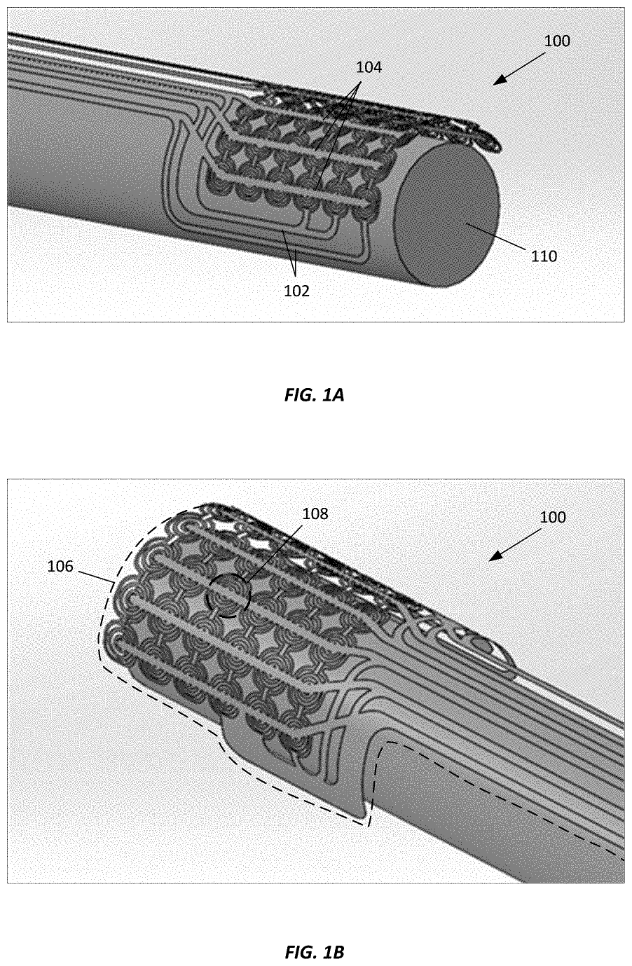

FIGS. 1A and 1B provide simplified views of a robotic manipulator member 100 enabled by the present disclosure. According to some implementations, conductive traces 102 and 104 are screen printed on a flexible substrate 106 (shown only in FIG. 1B) and one or more pieces of conductive force-sensitive material 108 (shown only in FIG. 1B) are affixed (e.g., thermally bonded or with pressure sensitive adhesive) to substrate 106 in contact with portions of traces 102 and 104 to form sensors. As shown in the example of FIGS. 1A and 1B, robotic member 100 may employ a simple cylindrically shaped component 110 as its primary mechanical structure. However, such an approach may not be as effective for sensing complex shapes. Therefore, as discussed below, implementations are enabled by the present disclosure that employ more complex shapes and mechanical structures for robotic manipulator members.

Some implementations described herein employ sensor devices or systems that include piezoresistive materials. Piezoresistive materials include any of a class of materials that exhibit a change in electrical resistance in response to mechanical force (e.g., pressure, impact, distortion, etc.) applied to the material. One class of implementations described herein includes conductive traces formed directly on or otherwise integrated with a flexible dielectric substrate with piezoresistive material that is adjacent and/or tightly integrated with the dielectric substrate and in contact with at least some of the traces on the dielectric. In some cases, the dielectric substrate is separate from and conforms to an underlying component or mechanical structure (e.g., as described with reference to FIG. 1B). In others, the traces are formed on or otherwise integrated with the underlying components or mechanical structure.

Another class of implementations enabled by the present disclosure includes conductive traces formed directly on or otherwise integrated with a substrate of piezoresistive material (e.g., a piezoresistive fabric) that conforms to an underlying component or mechanical structure.

When force is applied to any of these implementations, the resistance between traces connected by the piezoresistive material changes in a time-varying manner that is representative of the applied force. Both one-sided and two-side implementations are contemplated, e.g., conductive traces can be printed or formed on one or both sides of a substrate. Implementations are also contemplated that include multiple layers of traces, e.g., in a printed circuit board assembly (PCBA) or other multi-layer structures.

A signal representative of the magnitude of the applied force is generated based on the change in resistance. This signal is captured via the conductive traces (e.g., as a voltage or a current), digitized (e.g., via an analog-to-digital converter), processed (e.g., by an associated processor, controller, or suitable circuitry), and mapped (e.g., by the associated processor, controller, or circuitry, or a separate control system) to a control function that may be used in conjunction with the control and/or operation of virtually any type of process, device, or system.

According to some implementations, the piezoresistive material with which the traces are in contact or on which the traces are formed may be any of a variety of woven or non-woven fabrics having piezoresistive properties. Implementations are also contemplated in which the piezoresistive material may be any of a variety of flexible, stretchable, or otherwise deformable materials (e.g., rubber, or a stretchable fabric such as spandex or open mesh fabrics) having piezoresistive properties. The conductive traces may be formed on the dielectric substrate or the piezoresistive material using any of a variety of conductive inks or paints. More generally, implementations are contemplated in which the conductive traces are formed using any conductive material that may be formed on either type of substrate. It should be understood with reference to the foregoing that, while specific implementations are described with reference to specific materials and techniques, the scope of this disclosure is not so limited.

According to a particular class of implementations, the piezoresistive material is a pressure sensitive fabric manufactured by Eeonyx, Inc., of Pinole, Calif. The fabric includes conductive particles that are polymerized to keep them suspended in the fabric. The base material (which may be, for example, a polyester felt) is selected for uniformity in density and thickness as this promotes greater uniformity in conductivity of the finished piezoresistive fabric. That is, the mechanical uniformity of the base material results in a more even distribution of conductive particles when the slurry containing the conductive particles is introduced. In some implementations, the fabric may be woven. Alternatively, the fabric may be non-woven such as, for example, a calendared fabric, e.g., fibers bonded together by chemical, mechanical, heat, or solvent treatment. For implementations in which conductive traces are formed on the piezoresistive fabric, calendared material may present a smooth outer surface which promotes more accurate screening of conductive inks.

The conductive particles in the fabric may be any of a wide variety of materials including, for example, silver, copper, gold, aluminum, carbon, etc. Some implementations may employ carbon graphene particles. Such materials may be fabricated using techniques described in U.S. Pat. No. 7,468,332 for Electroconductive Woven and Non-Woven Fabric issued on Dec. 23, 2008, the entire disclosure of which is incorporated herein by reference for all purposes. However, it should again be noted that any of a wide variety of materials that exhibit a change in resistance or conductivity when force is applied to the material may be suitable for implementation of sensors as described herein.

According to a particular class of implementations, conductive traces having varying levels of conductivity are formed on a dielectric substrate or piezoresistive material using conductive silicone-based inks manufactured by, for example, E.I. du Pont de Nemours and Company (DuPont) of Wilmington, Delaware, and/or Creative Materials of Ayer, Massachusetts. An example of a conductive ink suitable for implementing highly conductive traces for use with various implementations is product number 125-19 from Creative Materials, a flexible, high temperature, electrically conductive ink. Examples of conductive inks for implementing lower conductivity traces for use with various implementations are product numbers 7102 and 7105 from DuPont, both carbon conductive compositions. Examples of dielectric materials suitable for implementing insulators for use with various implementations are product numbers 5018 and 5036 from DuPont, a UV curable dielectric and an encapsulant, respectively. These inks are flexible and durable. The degree of conductivity for different traces and applications may be controlled by the amount or concentration of conductive particles (e.g., silver, copper, aluminum, carbon, etc.) suspended in the silicone. These inks can be screen printed or printed from an inkjet printer. According to some implementations, the substrate on which the inks are printed are non-stretchable allowing for the use of less expensive inks that are low in flexibility and/or stretchability. Another class of implementations uses conductive paints (e.g., carbon particles mixed with paint) such as those that are commonly used for EMI shielding and ESD protection.

Additional examples of sensor technology and related techniques that may be used with various implementations enabled by the present disclosure are described in U.S. Pat. No. 8,680,390 entitled Foot-Operated Controller issued on Mar. 25, 2014, U.S. Pat. No. 9,076,419 entitled Multi-Touch Pad Controller issued on Jul. 7, 2015, U.S. Pat. No. 9,965,076 entitled Piezoresistive Sensors and Applications issued on May 8, 2018, U.S. Pat. No. 9,442,614 entitled Two-Dimensional Sensor Arrays issued on Sep. 13, 2016, U.S. Pat. No. 9,753,568 entitled Flexible Sensors and Applications issued on Sep. 5, 2017, U.S. Pat. No. 9,863,823 entitled Sensor Systems Integrated With Footwear issued on Jan. 9, 2018, U.S. Pat. No. 10,362,989 entitled Sensor System Integrated With a Glove issued on Jul. 30, 2019, U.S. Patent Publication No. 2017/0305301 entitled Vehicle Seat Sensor Systems for Use With Occupant Classification Systems published on Oct. 26, 2017, and U.S. Pat. No. 9,721,553 entitled Sensor-Based Percussion Device issued on Aug. 1, 2017. The entire disclosure of each of the foregoing patent documents is incorporated herein by reference for all purposes. However, it should also be noted that implementations are contemplated that employ other suitable sensor technologies in a wide variety of applications. The scope of this disclosure should therefore not be limited by reference to these examples.

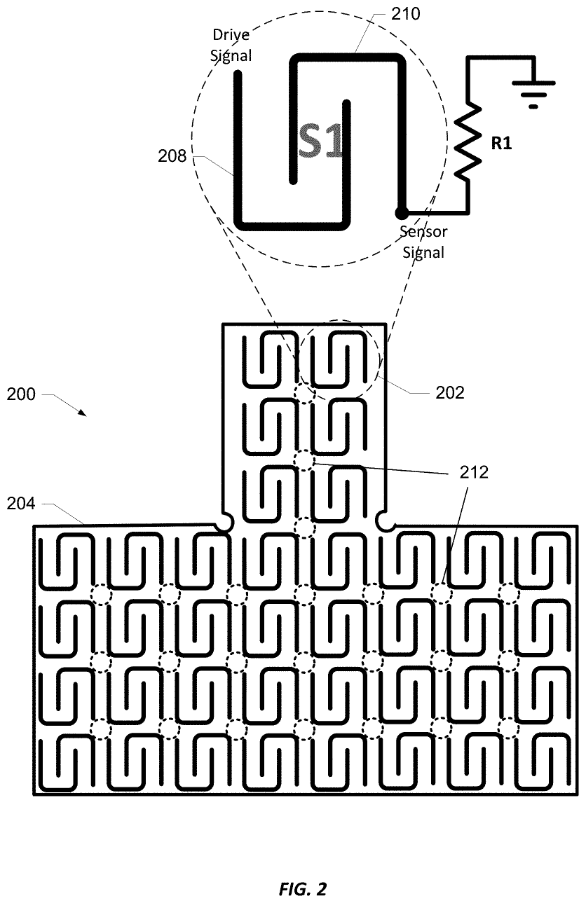

FIG. 2 illustrates an example of a sensor array 200 enabled by the present disclosure. The specific implementation shown in FIG. 2 includes 38 sensors that capture force data from different areas of the array. The sensors are implemented with conductive trace patterns 202 that are formed directly on or otherwise integrated with a flexible substrate 204. In the depicted implementation, flexible substrate 204 is a flexible dielectric material such as, for example, thermoplastic polyurethane (TPU), polyethylene terephthalate (PET), or Kapton (a polyimide material developed by DuPont).

According to a particular class of implementations, flexible substrate 204 is a flexible circuit board made, for example, from Kapton and having a thickness of about 0.1 mm per layer. A typical implementation might include three or more layers. As will be appreciated by those of skill in the art, this type of substrate allows for features (such as conductive traces) under 0.02 mm, enabling sensor arrays with a high degree of resolution as compared to sensors typically used with conventional robotic manipulators.

According to various implementations, and as will be described, flexible substrate 204 may be folded such that the sensor array securely conforms to an underlying component or mechanical structure. And because the flexible substrate conforms to the various contours of the underlying component or mechanical structure, reliable operation of the sensor array in conjunction with the robotic manipulation of objects may be realized.

At each sensor location, a conductive (e.g., piezoresistive) material (not shown) is tightly integrated with dielectric material 204 such that it makes contact with one or more of the sensor trace patterns 202. In some implementations, the piezoresistive material is a contiguous sheet of material that contacts multiple sensor trace patterns up to an including the entire array. In other implementations, the piezoresistive material is in multiple pieces, each of which contacts one or a subset of the sensor trace patterns.

Sensor trace patterns 202 are on the surface of dielectric material 204 facing the piezoresistive material. Signal routing traces (not shown for clarity) route drive signals from associated sensor circuitry (not shown) to each of the sensors, and the resulting sensor signals from each of the sensors to the sensor circuitry. Depending on the implementation, these signal routing traces may be on the same surface of substrate 204 as the sensor trace patterns, on the opposite surface of substrate 204 (e.g., connected to the sensors by vias), and/or, for implementations in which substrate 204 includes multiple layers, in or on any of the layers of substrate 204.

In the depicted implementation, each of sensor trace patterns 202 in the array includes two closely spaced traces. See, for example, the magnified view of sensor S1. The depicted U-shaped traces represent only one example of the possible trace shapes and configurations that might be effectively employed. For example, in some implementations, each of the traces for a sensor might include extensions that form comb-like structures that alternate with the extensions of the other trace. In another example, a sensor might include more than two traces. Other examples of sensor trace configurations that may be employed by implementations enabled by the present disclosure are provided in the U.S. patent documents incorporated herein by reference above.

In the example depicted in FIG. 2, one of the traces 208 receives a drive signal; the other trace 210 transmits the resulting sensor signal to associated sensor circuitry (not shown). The drive signal might be provided, for example, by connecting trace 208 (permanently or temporarily) to a voltage reference, a signal source that may include additional information in the drive signal, a GPIO (General Purpose Input Output) pin of an associated processor or controller, etc. And as shown in the example in FIG. 2, the sensor signal might be generated using a voltage divider in which one of the resistors of the divider includes the resistance between the two traces through the intervening piezoresistive material. The other resistor (represented by R1) might be included, for example, with the associated sensor circuitry. As the resistance of the piezoresistive material changes with applied force, the sensor signal also varies as a divided portion of the drive signal. The sensors are energized (via the drive signals) and interrogated (via the sensor signals) to generate an output signal for each that is a representation of the force exerted on that sensor. As will also be appreciated, and depending on the application, implementations are contemplated having more or fewer sensors that may be arranged in any of a wide variety of configurations.

According to various implementations, different sets of sensors may be selectively energized and interrogated thereby reducing the number and overall area of traces on/in the substrate, as well as the connections to sensor circuitry (not shown). For example, in the sensor system depicted in FIG. 2, the 38 sensors may be driven and sensed using a column-and-row drive/sense scheme that employs 8 column/drive signals and 7 row/sense signals. This may be compared to an implementation in which each sensor has its own dedicated pair of signal lines (i.e., 38 sensors; 76 signal lines). The set of sensors providing sensor signals to the sensor circuitry may be energized in any suitable sequence or pattern such that any signal received on a particular sensor signal input can be correlated with the corresponding sensor drive signal by the sensor circuitry.

And because the sensor signals in some implementations are received by the sensor circuitry via multiple different sensor signal inputs, multiple sensors can be simultaneously energized as long as they are connected to different sensor signal inputs to the sensor circuitry. This allows for the sharing of drive signal lines. The sharing of common drive signal lines may be enabled in some cases by insulators which allow the conductive traces on the same surface or in the same layer to cross. In other cases, such conductive traces might simply diverge. In still other cases, sensors may share common drive signals that originate and then diverge before reaching the assembly. Thus, according to some implementations, a relatively few drive signals might be needed for energizing the all of the sensors.

More generally, the number of signal lines used to drive the sensors of the array, the number of signal lines used to capture the sensor signals, and the manner in which the signal lines in each group may be shared will vary considerably from implementation to implementation. Some of the issues that influence design decisions around this include, for example, the topology of the array. That is, these design choices are highly dependent on how a signal exits each sensor and how well each lines up with the location of the assembly that connects to the outside world (e.g., a connector, a PCB interface, etc.). Another issue relates to sensor output levels. That is, if the sensor output levels are expected to be low, it may be advantageous to provide a more direct path to the connector or sensor circuitry by having more lines for sensor signals with fewer sensors sharing each line. This also may have the advantage of reducing crosstalk between sensors. And for implementations in which even small amounts of crosstalk are undesirable, the lines carrying the sensor output signals to the sensor circuitry may be terminated with a non-inverting op-amp which presents virtual ground. Other suitable variations on these themes will be understood by those of skill in the art to be within the scope of this disclosure.

According to some implementations, flexible substrate 204 may include apertures 212 for receiving posts (not shown) extending from other system components such as, for example, the underlying component to which substrate 204 conforms or an overlying component such as a silicone substrate encasing the device. Such posts (which may also extend through the piezoresistive material) may serve to keep the various components of the robotic manipulator member aligned even in the face of lateral shearing forces that occur during manipulation of objects.

Flexible substrate 204 may also include cutouts (e.g., 214) at locations that promote folding of the substrate such that it conforms to the contours of an underlying component.

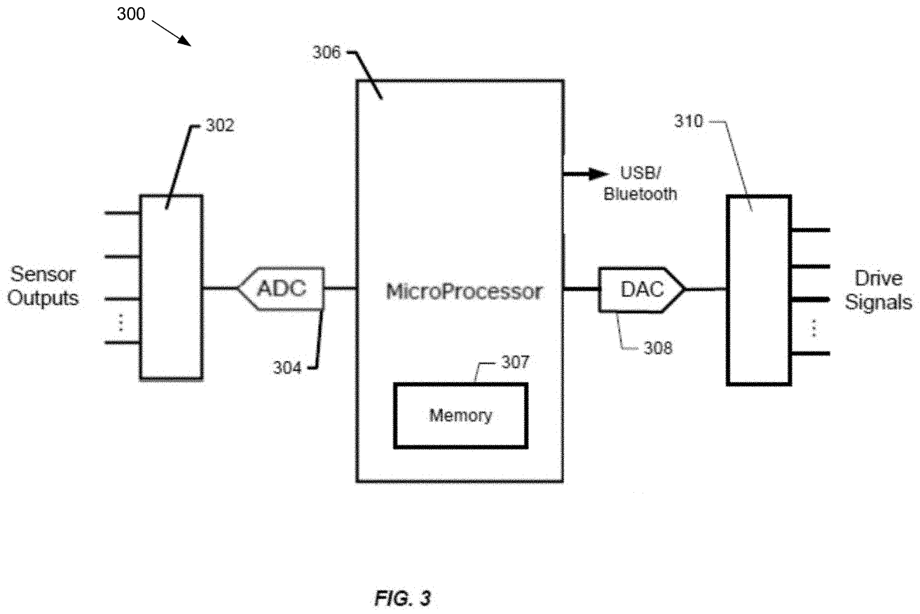

FIG. 3 is a simplified diagram of sensor circuitry 300 for use with implementations described herein. The depicted circuitry may be provided, for example, on a printed circuit board assembly (PCBA) associated with a sensor array such as the one described above with reference to FIG. 2 or any of those described below. When pressure is applied to one of the sensors, a resulting signal (captured via the corresponding traces) is received and digitized (e.g., via multiplexer 302 and A-to-D converter 304) and may be processed locally (e.g., by processor 306) and/or transmitted (via wires or wirelessly) to a connected device (e.g., via a USB or Bluetooth connection). The sensors may be selectively driven or energized by the sensor circuitry (e.g., under the control of processor 306 via D-to-A converter 308 and multiplexer 310) resulting in the generation of the sensor signals.

In addition to transmission of data to and from a connected device, power may be provided to the sensor circuitry via a wired interface, e.g., a USB connection. Alternatively, systems that transmit data wirelessly (e.g., via Bluetooth or wireless USB) may provide power to the sensor circuitry using any of a variety of mechanisms and techniques including, for example, using one or more batteries, solar cells, and/or mechanisms that harvest mechanical energy. The LTC3588 (provided by Linear Technology Corporation of Milpitas, Calif.) is an example of an energy harvesting power supply that may be used with at least some of these diverse energy sources. Other suitable variations will be appreciated by those of skill in the art. And as will be appreciated, the sensor circuitry 300 is merely an example. A wide range of sensor circuitry components, configurations, and functionalities are contemplated. An example of a device suitable for implementing processor 156 is the C8051F380-GM controller provided by Silicon Labs of Austin, Tex.

In some cases, the responses of the sensors in arrays suitable for use with implementations enabled by the present disclosure may exhibit variation relative to each other. Therefore, calibrated sensor data may be stored (e.g., in memory 307 of processor 306) representing the response of each of the sensors over a range of applied forces and possibly other parameters as well (e.g., temperature, pressure, humidity, etc.). Such data may be used for ensuring consistency in the way the sensor outputs are processed and/or used to represent applied forces. During calibration, the output of each sensor (e.g., as captured by ADC 304) is measured for a range of known input forces. This may be done, for example, by placing each sensor on a scale, applying force to that sensor, and recording a value in memory for each of a plurality of ADC values that represents a corresponding value reported by the scale. In this way, a set of data points for each sensor is captured (e.g., in a table in memory 307) associating ADC values with corresponding forces (e.g., weights in grams or kilograms). The data set for each sensor may capture a force value for every possible value of the ADC output. Alternatively, fewer data points may be captured and the sensor circuitry may use interpolation to derive force values for ADC outputs not represented in the data set.

Sensor data stored and/or used by sensor circuitry 300 may also represent or account for simultaneous contributions from multiple sensors (e.g., immediately adjacent or nearby sensors) that allow for determinations of positional resolution that exceed the positional resolution determined solely by the number of sensors in the associated array.

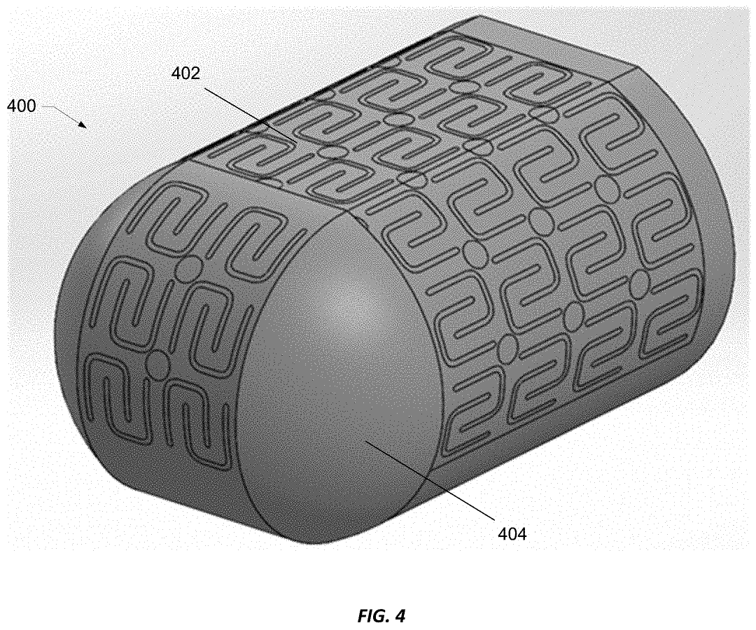

According to a particular class of implementations depicted in FIG. 4, a robotic manipulator member 400 is formed by conforming a sensor array 402 (e.g., array 200 of FIG. 2 or any of the arrays described below) to an underlying component 404 as depicted in FIG. 4. Component 404 (which may be, for example, a molded or 3D-printed component) has a number of distinct exterior surfaces, some of which may be substantially flat, others of which may have varying degrees of curvature. The configuration of these exterior surfaces and the shape and flexibility of sensor array 402 allow for different portions of sensor array 402 to conform securely to corresponding exterior surfaces. As will be appreciated, the better the mechanical alignment of the sensors of array 402 to the underlying exterior surfaces of component 404, the more reliable the operation of the sensors. The depicted robotic manipulator member 400 may operate as part of a robotic finger (e.g., a fingertip). As will also be appreciated, the number and curvatures of the exterior surfaces of the underlying component may vary depending on the application and the shape and size of the sensor array.

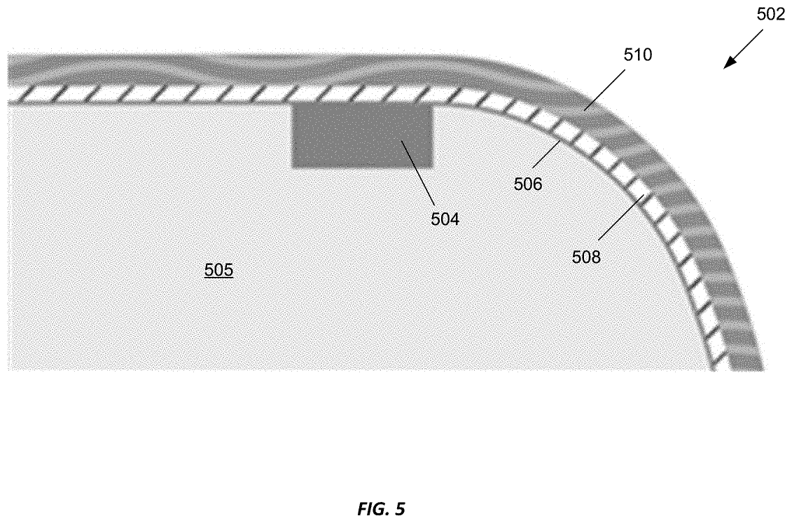

According to some implementations, the sensor circuitry (e.g., sensor circuitry 300) that activates and reads the sensors may be located adjacent the side of the substrate or printed circuit board assembly (PCBA) opposite the side on which the sensor trace patterns are located. This arrangement may be understood with reference to the partial cross section of a robotic manipulator member 502 shown in FIG. 5. In the depicted implementation, sensor circuitry 504 is shown within the body of underlying component 505 (e.g., within a recess or aperture), immediately adjacent substrate 506 with which the sensor traces and signal routing traces (not shown) are integrated.

Piezoresistive material 508 (which may be piezoresistive fabric) is adjacent substrate 506 in contact with the sensor traces. In this example, the piezoresistive material is shown as being contiguous across the sensor array, but it will be appreciated that the piezoresistive material may be deployed as discontinuous pieces (e.g., patches or strips) as described elsewhere herein. Piezoresistive material 508 may be attached to substrate 506 with a pressure sensitive adhesive (PSA), preferably at locations that do not interfere with the connection between the piezoresistive material and the sensor traces. Alternatively, piezoresistive material 508 may be attached to substrate 506 by thermally bonding the piezoresistive material to the substrate using, for example, a layer of thermoplastic polyurethane (TPU); overlying the piezoresistive material and/or as substrate 506.

According to some implementations, a molded silicone cover 510 protects the underlying sensor array and/or provides friction for enhancing a manipulator's grip on objects. Depending on the application, silicone cover 510 may have a variety of different shapes, thicknesses, and textures as might be suitable for the underlying component and/or for the types and shapes of object being manipulated.

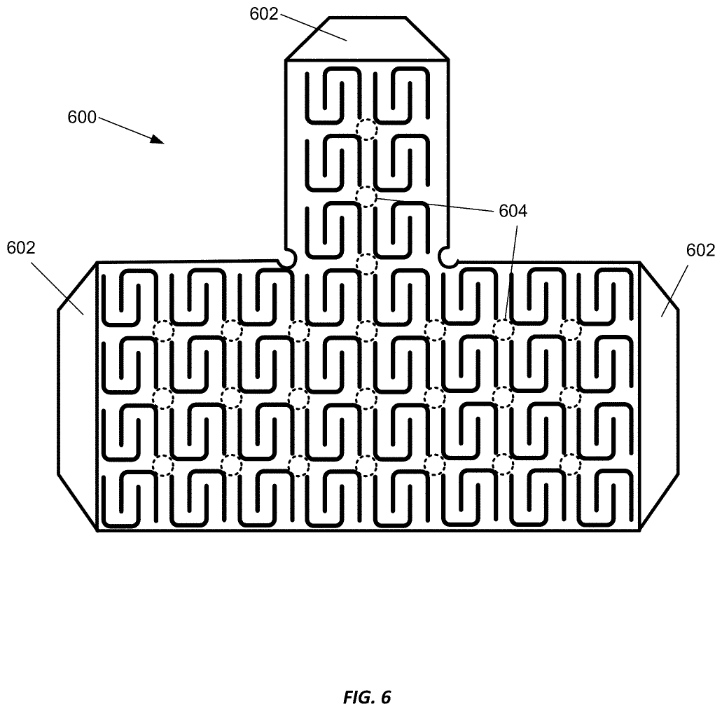

According to some implementations and as depicted in FIG. 6, a sensor array 600 constructed in a manner similar to sensor array 200 of FIG. 2 may include flaps 602 configured for securing the array to an underlying component (e.g., to component 404 of FIG. 4). For example, such flaps can be secured using bezels and/or other mechanical components such as, for example, screws or rivets. And as described above with reference to FIG. 2, sensor array 600 may include apertures 604 to receive posts formed on the underlying component and/or overlying substrate (e.g., a silicone cover) for the purpose of aligning the assemblies and/or prevent shear.

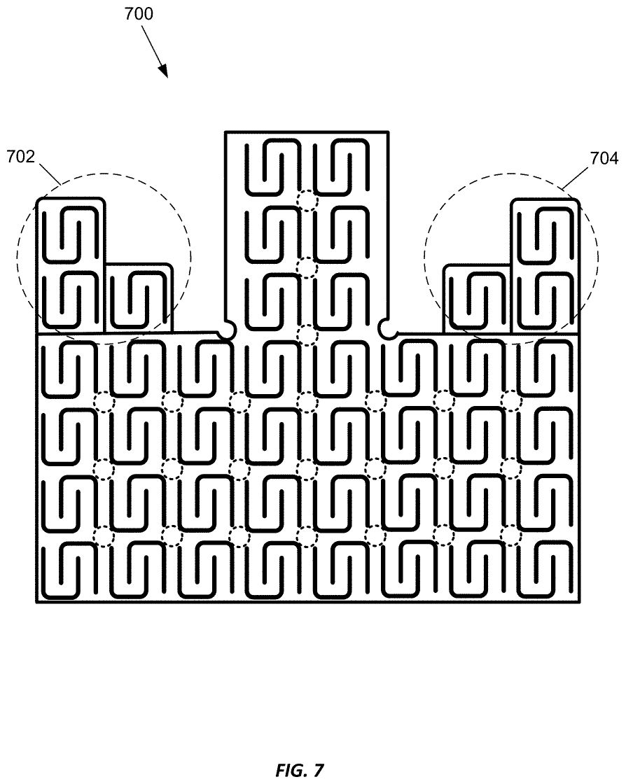

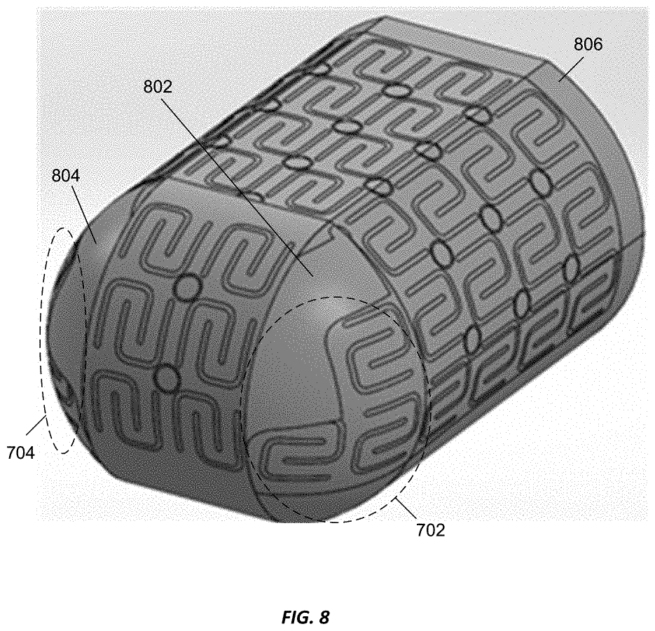

FIG. 7 depicts yet another sensor array 700 constructed in a manner similar to sensor array 200 that includes additional groups of sensors (702 and 704) relative to arrays 200 and 600 that provide additional coverage around the edges of the manipulator member (e.g., near the fingertip). As shown in FIG. 8, the portions of array 700 including sensors 702 and 704 conform to corresponding surfaces 802 and 804, respectively, of component 806 which may be constructed similarly to component 404 of FIG. 4.

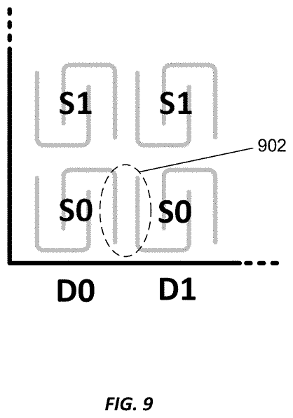

According to some implementations, the sensors of sensor arrays enabled by the present disclosure may be driven and sensed in a variety of different ways. As discussed above, this may involve driving and/or sensing multiple sensors substantially simultaneously. For example, for an array in which the sensors are arranged in rows and columns, the sensors of a particular column may be simultaneously energized while each of the rows intersecting that column are sensed. However, such a drive/sense scheme may result in cross-talk between adjacent sensors, particularly for implementations in which the piezoresistive material is contiguous across multiple sensors. This may be understood with reference to FIG. 9.

In the depicted example, if column D0 is energized, and force is applied at a location somewhere between the intersection of column D0 and row S0 and the intersection of column D1 and row S0, current may pass into the adjacent sensors of row S0 because of the parallel adjacency (902) of the conductors of the adjacent sensors. As will be appreciated, such crosstalk may result in inaccurate determination of the location of the force. A variety of mechanisms may be employed for reducing the effects of such crosstalk. For example, the piezoresistive material with which the sensors of the array are constructed may be discontinuous such that each portion of the piezoresistive material is only in electrical contact with the traces of a single sensor. In another example, contributions from adjacent sensors may be separately determined and subtracted as described in U.S. Pat. No. 9,863,823, incorporated herein by reference above.

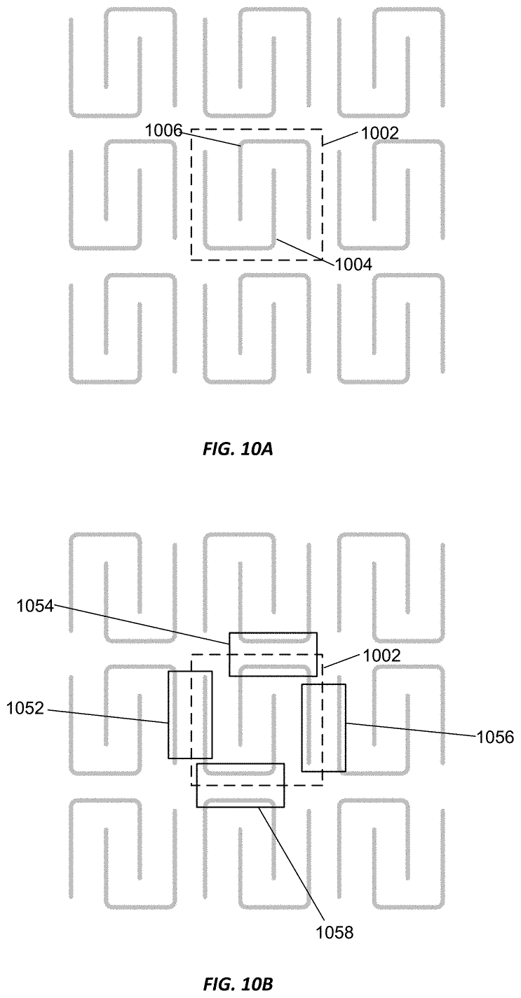

In some implementations, it is possible to take advantage of crosstalk between adjacent sensors of a sensor array to to increase the spatial resolution with which the location and/or distribution of forces may be determined. This may be understood with reference to FIGS. 10A and 10B. FIG. 10A shows a sensor area 1002 of a sensor that includes sensors traces 1004 and 1006 according to one class of implementations, i.e., a class of implementations in which each sensor's area is defined by the area of the array occupied by that sensor. As discussed above, such implementations typically employ one or more mechanisms for reducing or mitigating the effects of crosstalk between adjacent sensors. As will be appreciated, in such an implementation, the position of a force acting on any given sensor cannot be determined any more precisely than somewhere within an area represented by sensor area 1002.

By contrast, FIG. 10B depicts an example of an implementation in which crosstalk between adjacent sensors is employed to increase the spatial resolution by which the location and/or distribution of a force can be determined. In the depicted implementation, the orientations of the sensor traces of every other row is flipped vertically relative to the orientations of the sensors in the adjacent rows. This optional configuration increases the parallel adjacencies of the traces of the sensors above and below a given sensor so that the vertically adjacent sensors have trace adjacencies (represented by boxes 1054 and 1058) of similar magnitude to trace adjacencies of the horizontally adjacent sensors (represented by boxes 1052 and 1056). These adjacencies form secondary paths for currents to flow, thereby creating secondary sensor areas relative to primary sensor area 1002 that may be leveraged to enhance positional resolution more precisely.

Closely spaced sensors can each be sensed with a particular drive line being driven, i.e., the drive line corresponding to the primary sensor. Signals received from the adjacent sensors can be used to interpolate the position corresponding to the primary sensor by determining the extent to which each of the adjacent sensors has been activated. According to various implementations, different numbers of adjacent sensors can be used to increase positional resolution. For example, instead of just the four adjacent sensors depicted in FIG. 10B, all eight sensors having adjacency (including the diagonally adjacent sensors) can be used. In other examples, only the vertically adjacent or only the horizontally adjacent sensors could be used to increase resolution in one dimension.

And depending on which adjacent sensors are employed, it will be understood that the contributions of different adjacent sensors may be measured differently for similar forces. For example, a diagonally adjacent sensor will register a different contribution than a horizontally adjacent sensor because of the reduced trace adjacency of the diagonal neighbor versus the horizontal neighbor. There may also be different contributions registered for vertically adjacent sensor relative to horizontally adjacent sensors given the relative lengths of their respective trace adjacencies. However, as will be appreciated, these differences can be handled with proper calibration of the sensors of the array to capture the different behaviors for different force distributions.

According to some implementations, sensor arrays for use with robotic manipulators may be realized without the use of a separate substrate for the sensor traces and/or the signal routing traces connecting the array to the associated sensor circuitry. Such implementations integrate some or all of these conductive traces in one or more layers within the body of the manipulator member itself. Thus, for example, an implementation with the same shape and size as manipulator member 400 of FIG. 4 may be achieved without a separate substrate for the sensor and/or signal routing traces. In such an implementation, the sensor traces exposed on the external surfaces of the manipulator member would be connected to one or more additional layers of signal routing traces integrated in the body of the component. Such an approach may support the placement of sensor and signal routing traces of arbitrary size in any location on or in a manipulator member.

In addition, it should be noted that implementations in which the sensor and signal routing traces are integrated with the manipulator member body may avoid limitations on the arrangement, shapes, and contours of the external surfaces of the manipulator member that may be imposed by the flexibility and/or shape of a separate external sensor array substrate. Thus, integrating the sensor and signal routing traces with the member itself may enable implementation that include more complex contours, more layers of traces, and/or integrated electronics. Other possible advantages may include greater density, ease of manufacturing, greater reliability, and/or greater strength.

Some of these implementations employ molded interconnect devices (MIDs) in which the conductive traces are molded along with the manipulator member. According to specific implementations, a process known as “Laser Direct Structuring” uses a thermoplastic material doped with a non-conductive metallic inorganic compound that is activated using a laser. The component is injection molded with minimal restrictions in terms of three-dimensional design freedom. A laser “writes” the course of each conductive trace on the plastic. Where the laser beam impinges on the plastic, the non-conductive metal additive forms a micro-rough track. The metal particles of these tracks form the locations for the subsequent metallization of conductive traces. The conductive traces arise precisely on these tracks in, for example, a copper bath. Successive layers of copper, nickel, and/or gold finish can be raised in this way. Suitable MIDs and related technology are available from Molex and 3M.

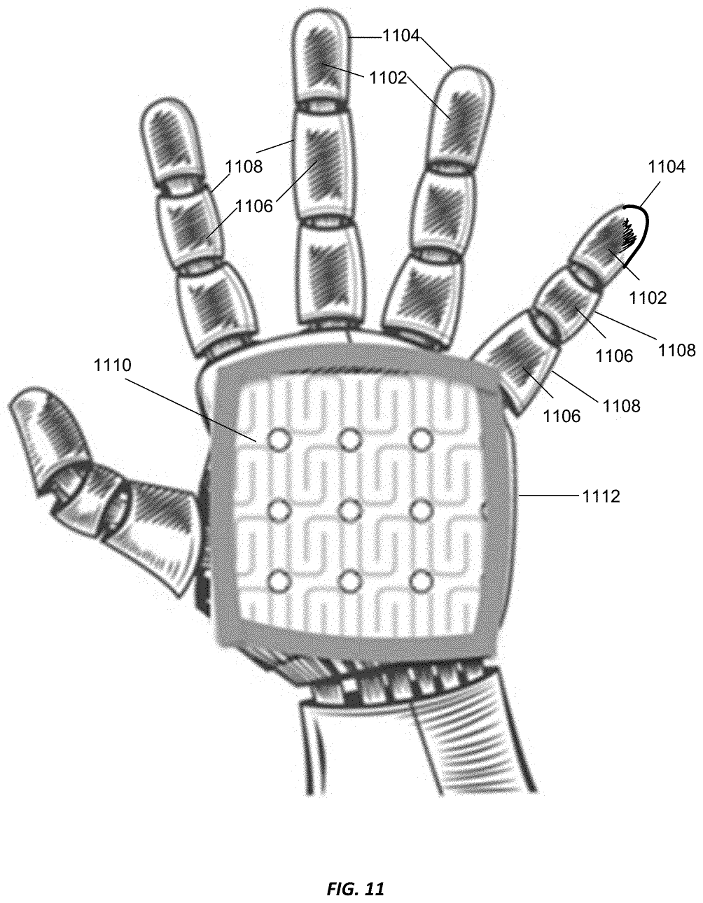

As will be appreciated with reference to the various implementations described herein, a robotic manipulator member may be implemented with a high degree of sensitivity relative to conventional robotic grippers and, in some cases, with sufficient resolution to mimic at least some of the functionality of a human fingertip. According to various implementations, multiple manipulator members with associated sensor arrays may be combined to implement an anthropomorphic robotic hand that mimics at least some of the functionality of a human hand. An example of such an implementation is depicted in FIG. 11.

In the depicted implementation, robotic hand 1100 includes sensor arrays 1102 positioned on each of fingertip components 1104, and sensor arrays 1106 positioned on each of phalange components 1108. Robotic hand 1100 also includes a palm sensor array 1110 (a portion of which is shown in magnification for illustrative purposes). Additional sensor arrays may also be integrated with other portions of the hand, e.g., sensor array 1112 along the edge of the hand.

The various sensor arrays of robotic hand 1100 may be implemented as described herein with the shape and/or flexibility of each array being tailored to the particular underlying component to which it conforms or with which it is integrated. The resolution of the force data reported by the sensor arrays associated with the various components of robotic hand 1100 may be collectively processed (by associated sensor circuitry) to provide considerable detail about an object being grasped by the hand. As will be appreciated, the number and sensitivity of the sensor arrays of robotic hand 1100 allows for a much greater degree of sophistication than conventional robotic grippers in terms of the grasping and manipulation of objects.

Some implementations that employ sensors that include piezoresistive fabric may provide levels of accuracy in terms of the magnitude of forces measured in the range of about ±15%. Such implementations may also be characterized by response times (e.g., the amount of time required for the fabric to approach its original resistance once a force is removed) that are not sufficient for some applications. According to some implementations, the sensor circuitry may employ a machine learning model to account for these issues and other nonlinear characteristics of sensing materials as described in U.S. Patent Publication No. 2020/0200621 entitled Modeling Nonlinear Characteristics of Materials for Sensor Applications, the entire disclosure of which is incorporated herein by reference for all purposes.

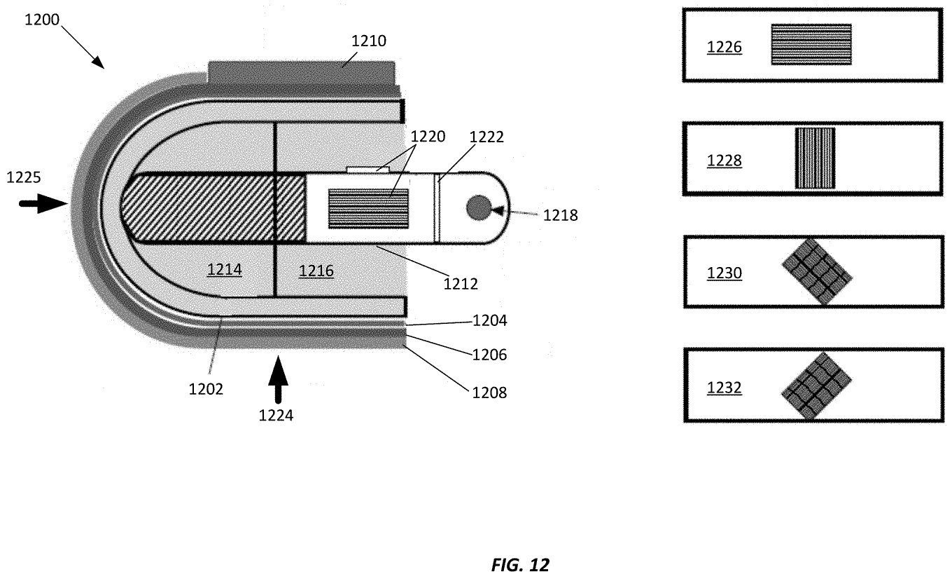

According to other implementations, a sensor blending approach is taken in which a second sensor assembly is used in conjunction with a higher-resolution sensor array. An example of such a sensor assembly is shown in FIG. 12 which includes a cross-section of a robotic manipulator member 1200.

Manipulator member 1200 includes a base component 1202 (e.g., a molded or 3D-printed component) to which a sensor trace array 1204 is secured, or with which sensor trace array 1204 is integrated. A piezoresistive fabric layer 1206 conforms to sensor trace array 1204 and contacts conductive sensor traces (not shown) on the surface of sensor trace array 1204. A silicone layer 1208 conforms to the sensor array and the underlying component, providing a protective layer and/or enhancing the gripping capabilities of manipulator member 1200. Layers 1204, 1206, and 1208 are secured to each other and component 1202 with “fingernail” component 1210 which may be a bezel or plate secured with screws, rivets, etc.

It should be noted that the aforementioned components of manipulator member 1200 are merely examples of the components and sensor types that may be employed with the second sensor assembly described below. For example, while the sensor array formed by sensor trace array 1204 and piezoresistive fabric 1206 may correspond to any of the sensor arrays described herein, it may also be implemented as any of a wide-variety of sensor array types not described herein. In another example, silicone layer 1208 may be implemented with a different material or be omitted altogether. The details of these components of manipulator member 1200 should therefore not be used to limit the scope of the implementation depicted.

A beam 1212 is positioned along the central longitudinal axis of component 1202, secured in a solid portion 1214 of component 1202 (e.g., via threads on either or both components), with a portion of beam 1212 extending into an interior volume 1216 of component 1202. Beam 1212 is secured at the other end (e.g., to another component of a robotic manipulator) via mounting hinge point 1218.

According to a specific implementation, beam 1212 has a rectangular cross-section and four faces, on at least two of which strain gauges 1220 are mounted or otherwise integrated. Strain gauges 1220 have high accuracy in representing force (e.g., typically better than 1%) and a faster response than fabric-based sensors, returning to zero very quickly once force is removed. Strain gauges 1220 respond to forces (e.g., force 1224) that cause flexing of the corresponding face of beam 1212 on which each is mounted. In the depicted implementation, there is also a load cell 1222 (e.g., a strain gauge in a quad configuration) integrated with beam 1212 and oriented to respond to forces (e.g., force 1225) acting straight on to the tip of manipulator member 1200. Sensor circuitry (e.g., the sensor circuitry 300 of FIG. 3) receives signals generated by strain gauges 1220 and load cell 1222, and determines the corresponding magnitudes and/or directions of the forces acting on those components.

According to some implementations, strain gauges 1220 may be arranged at different orientations on the faces of beam 1212 (e.g., orientations 1226-1232) and can be read independently to capture different types of flexing. More than one strain gauge may be mounted on the same beam face at different orientations.

According to some implementations, the beam may have different cross-sections with more or fewer faces than beam 1212. As will be appreciated, more faces may allow for detection of force components in more directions thereby providing greater sensitivity.

The sensor assembly represented by beam 1212 and its components allows for fast acquisition of an accurate representation of the magnitude of a force being applied to manipulator member 1200. Acquisition of this force may be accompanied by a higher-resolution capture of the distribution of that force using signals generated by the sensor array integrated with the outer surface of manipulator member 1200, e.g., the sensor array formed by sensor trace array 1204 and piezoresistive fabric 1206. That is, based on the locations and contributions of the active sensors of the sensor array, the distribution of the force(s) detected using the strain gauges and/or load cell associated with beam 1212 can be estimated (e.g., by the sensor circuitry 300). This blended approach provides a fast and accurate force determination, while still providing the spatial resolution of the array.

It will be understood by those skilled in the art that changes in the form and details of the implementations described herein may be made without departing from the scope of this disclosure. In addition, although various advantages, aspects, and objects have been described with reference to various implementations, the scope of this disclosure should not be limited by reference to such advantages, aspects, and objects. Rather, the scope of this disclosure should be determined with reference to the appended claims.

What is claimed is:

1. A device, comprising:
a component having a plurality of distinct exterior surfaces;
a sensor array arranged on a flexible substrate, the sensor array including a plurality of sensors, wherein the flexible substrate is configured to fold such that the flexible substrate substantially conforms to the exterior surfaces of the component, and each of a plurality of distinct subsets of the sensors is aligned with a corresponding one of the exterior surfaces of the component; and
circuitry configured to receive sensor signals from the sensors of the sensor array, and to process the sensor signals to generate force data representing forces on the device.

2. The device of claim 1, further comprising a beam within an interior volume of the component, the beam being aligned with a central axis of the component and including one or more strain gauges integrated therewith, wherein the beam is configured to be secured within the component such that the forces on the device cause the beam to flex, wherein the circuitry is configured to receive one or more strain gauge signals generated using the one or more strain gauges, and wherein the circuitry is configured to generate the force data using the one or more strain gauge signals.

3. The device of claim 2, wherein the circuitry is configured to determine a force magnitude for a first force using the one or more strain gauge signals, and a force location for the first force using the sensor signals.

4. The device of claim 2, wherein the beam is secured to the component at a first end of the beam, and the beam is configured to be secured to an external structure at a second end of the beam.

5. The device of claim 2, wherein the beam has a rectangular cross-section.

6. The device of claim 5, wherein the one or more strain gauges include a first strain gauge integrated with a first face of the beam and a second strain gauge integrated with a second face of the beam.

7. The device of claim 6, wherein the first and second strain gauges are oriented differently relative to the axis of the component.

8. The device of claim 1, wherein at least one of the exterior surfaces of the component is substantially flat.

9. The device of claim 1, wherein at least one of the exterior surfaces of the component is curved.

10. The device of claim 1, wherein each sensor of the sensor array includes at least two conductive sensor traces and piezoresistive material in contact with the sensor traces.

11. The device of claim 10, wherein the piezoresistive material is a piezoresistive fabric.

12. The device of claim 10, wherein the piezoresistive material of each sensor is part of a contiguous substrate of the piezoresistive material that coincides with more than one of the sensors.

13. The device of claim 10, wherein the piezoresistive material of each sensor is a patch of the piezoresistive material that coincides with only the corresponding sensor.

14. The device of claim 1, further comprising a silicone cover encasing the component and the sensor array.

15. The device of claim 1, wherein the circuitry is contained within an interior volume of the component.

16. The device of claim 1, wherein the circuitry is configured to generate the force data with a positional resolution limited by a number of the sensors in the sensor array.

17. The device of claim 1, wherein the circuitry is configured to generate the force data with a positional resolution that is greater than a limit defined by a number of the sensors in the sensor array.

18. The device of claim 17, wherein each of the sensors is characterized by a sensor trace topology, and wherein the sensor trace topology for a first sensor is flipped relative to the sensor trace topology of a second sensor that is adjacent the first sensor.

19. A device, comprising:
a component;
a beam within an interior volume of the component, the beam being aligned with a central axis of the component and including one or more strain gauges integrated therewith, wherein the beam is configured to be secured within the component such that forces on the device cause the beam to flex; and
circuitry configured to receive one or more strain gauge signals generated using the one or more strain gauges, and to generate force data representing the forces on the device using the one or more strain gauge signals.

20. The device of claim 19, further comprising a sensor array arranged on one or more exterior surfaces of the component, wherein the circuitry is configured to determine a force magnitude for a first force using the one or more strain gauge signals, and a force location for the first force using sensor signals received from the sensor array.

21. The device of claim 20, wherein the component has a plurality of distinct exterior surfaces, wherein sensors of the sensor array are arranged on a flexible substrate, and wherein the flexible substrate is configured to fold such that the flexible substrate substantially conforms to the exterior surfaces of the component, and such that each of a plurality of distinct subsets of the sensors is aligned with a corresponding one the exterior surfaces of the component.

22. The device of claim 19, wherein the beam is secured to the component at a first end of the beam, and the beam is configured to be secured to an external structure at a second end of the beam.

23. The device of claim 19, wherein the beam has a rectangular cross-section.

24. The device of claim 23, wherein the one or more strain gauges include a first strain gauge integrated with a first face of the beam and a second strain gauge integrated with a second face of the beam.

25. The device of claim 24, wherein the first and second strain gauges are oriented differently relative to the axis of the component.
